(19) United States
(12) Patent Application Publication
(10) Pub. No.: US 2004/0066373 A1
(43) Pub. Date: Apr. 8, 2004

(54) Foldable computer keyboard

(76) Inventor: Michael Wu, Hsin Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/263,746

(22) Filed: Oct. 4, 2002

(51) Int. Cl. G09G 5/08

(52) U.S. Cl. 345/168

(57) ABSTRACT

A foldable keyboard includes first, second, third and fourth segments, each movably supporting operation keys thereon. The first and fourth segments have an inner edge forming a channel defined by two opposite side walls, each defining a slot terminating at a rounded end. A connecting tab has a first end forming pivot pins movably received in the slots for retrievably receiving the connecting tab in the channel and allowing the connecting tab to rotate with respect to the first or fourth segment about the pivot pins at the rounded end. The connecting tab has a second end pivotally attached to a distal edge of the second or third segment for rotation with respect thereto. The second and third segments have a proximal end forming a channel defined by two opposite side walls each forming a slot terminating at a rounded end. A central tab has ends retrievably received in the channels of the second and third segments. Pivot pins extending from the central tab are received in the slots of the channels to allow the central tab to rotate with respect to the second and third segments.

### BACKGROUND OF THE INVENTION

1. Field of the Invention

The present invention relates generally to a computer keyboard, and in particular to a foldable computer keyboard.

2. The Related Art

Keyboards are one of the most commonly used input devices for computers. The keyboard comprises a flat, rectangular base having a top face on which a number of operation keys are movably mounted. The base is made of rigid plastic material that makes it impossible to be folded. With the trend of miniaturization of computers and peripheral devices, the overall size of keyboards is substantially reduced, such as the key pad of a notebook computer. Some of the electronic devices employ a “touch panel” to replace the keyboard. An example of the electronic devices that employs the touch panel is a Personal Digital Assistant (PDA). Since the PDA has a display screen having a very limited surface area for display. The touch panel is integrated with the display and thus is limited in size. This makes it difficult for a user to “touch” precisely the desired zones on the display surface of the PDA. Thus, an external keyboard may be required for helping data input into the PDA. However, a conventional rigid keyboard has a size much larger than a PDA and it thus not suitable for use with the PDA as a portable device. Thus, a foldable keyboard is more appropriate.

Foldable computer keyboards that comprise several pieces or segments movably connected together to selectively form a full size keyboard or a folded, stowed condition are known in the art. One type of the prior art foldable keyboards comprises a number of separated segments connected by a flexible member that is deflectable and/or bendable to allow the segments to overlap each other. These conventional designs of foldable keyboard suffer from slacks of the flexible member when the keyboard is expanded to a full size keyboard. Another type of prior foldable keyboards comprises several segments pivoted to each other. The expanding operation of the keyboards, however, is complicated and awkward.

### SUMMARY OF THE INVENTION

Thus, a primary object of the present invention is to provide a foldable computer keyboard that has a simple structure and that is easy to operate.

Another object of the present invention is to provide a foldable keyboard for a Personal Digital Assistant (PDA).

To achieve the above objects, in accordance with the present invention, there is provided a foldable keyboard comprising first, second, third and fourth segments, each movably supporting operation keys thereon. The first and fourth segments have an inner edge forming a channel defined by opposite side walls, each defining a slot terminating at a rounded end. A connecting tab has a first end forming pivot pins movably received in the slots for retrievably receiving the connecting tab in the channel and allowing the connecting tab to rotate with respect to the first or fourth segment about the pivot pins at the rounded end. The connecting tab has a second end pivotally attached to a distal edge of the second or third segment for rotation with respect thereto. Thus, the first and fourth segments are stackable on the second and third segments. The second third segments have a proximal end forming a channel defined by opposite side walls each forming a slot terminating at a rounded end. A central tab has ends retrievably received in the channels of the second and third segments. Pivot pins extending from the central tab are received in the slots of the channels to allow the central tab to rotate with respect to the second and third segments. The central tab allows the second and third segments with the first and fourth segments stacked thereon to further stack over each other.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of a foldable keyboard in accordance with the present invention in an unfolded condition where segments of the keyboard are not secured together to form a complete, operative keyboard;

FIG. 2 is a perspective view of the foldable keyboard in an expanded, operative condition;

FIG. 3 is a perspective view similar to FIG. 1 with operation keys of the keyboard shown with phantom lines to show inside details of the foldable keyboard of the present invention;

FIG. 4 is a cross-sectional view of the keyboard in the operative condition along line 4-4 of FIG. 2;

FIG. 5 is a cross-sectional view of the keyboard in the unfolded condition along line 5-5 of FIG. 1;

FIG. 6 is a cross-sectional view of the keyboard in a partially folded condition; and

FIG. 7 is a cross-sectional view of the keyboard in a fully folded condition.

### DETAILED DESCRIPTION OF THE PREFERRED EMBODIMENTS

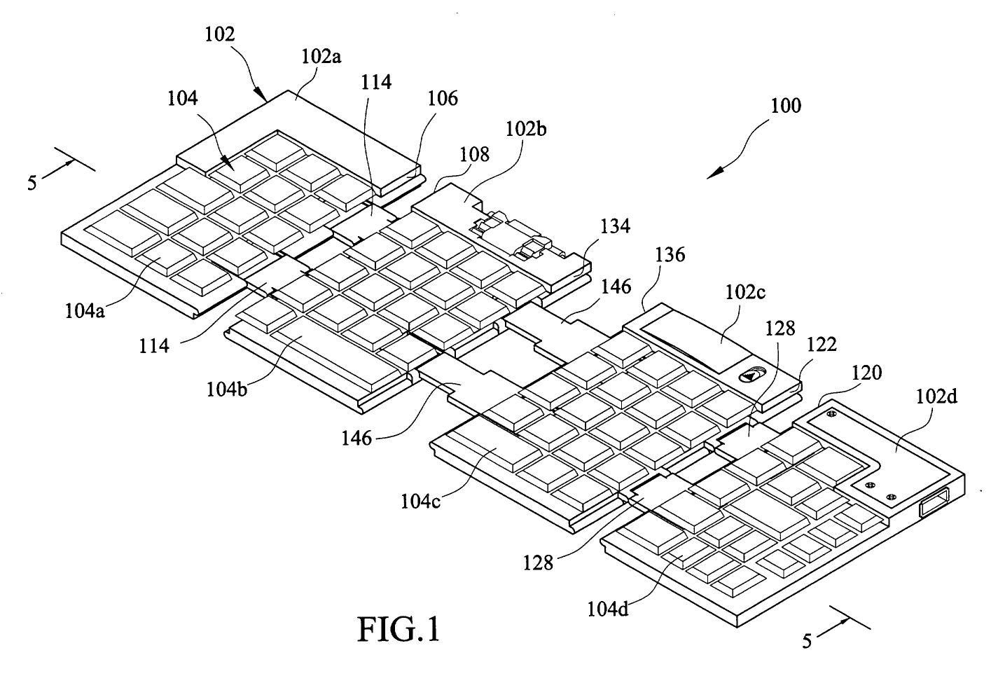

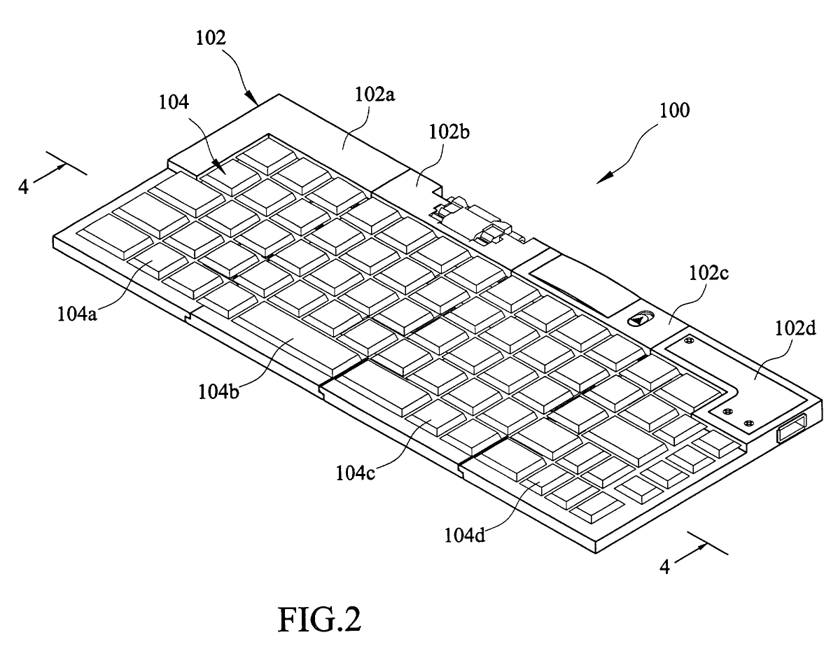

With reference to the drawings and in particular to FIGS. 1 and 2, a foldable keyboard constructed in accordance with the present invention, generally designated with reference numeral 100, comprises a frame 102 and a number of operation keys 104 operatably arranged on a top face (not labeled) of the frame 102. The frame 102 is divided into four segments 102a, 102b, 102c, 102d. The operation keys 104 are divided into four groups 104a, 104b, 104c, 104d respectively associated with the four segments 102a, 102b, 102c, 102d of the frame 102. The four segments 102a, 102b, 102c, 102d have substantially the same size whereby they can be stacked over each other as shown in FIG. 7.

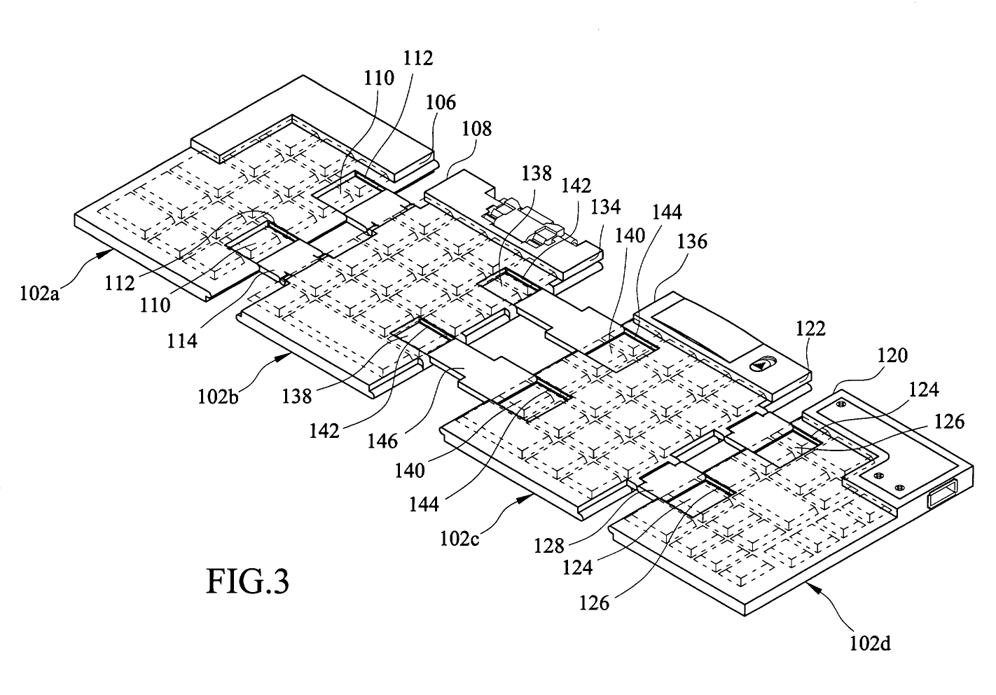

Also referring to FIG. 3, the first segment 102a has an inner edge 106 facing a first edge 108 of the second segment 102b. Two channels 110 are formed in the inner edge 106 of the first segment 102a and each defined by two opposite side walls (not labeled). A guide slot 112 is formed in each side wall of the channel 110. Two tabs 114 have an end (not labeled) rotatably connected to the first edge 108 of the second segment 102b by a pivot 116 and an opposite end (not labeled) movably received in the channels 110. Thus the tabs 114 are retrievably received in the channels 110. Pivot pins 118 extend from opposite sides of each tab 114 and are movably received in the guide slots 112 for guiding the movement of the first and second segments 102a, 102b relative to each other. Each slot 112 is terminated with a rounded end for rotation of the pivot pins 118 therein. Thus, the tabs 114 are rotatable with respect to the first and second segments 102a, 102b about the pivots 116 and 118.

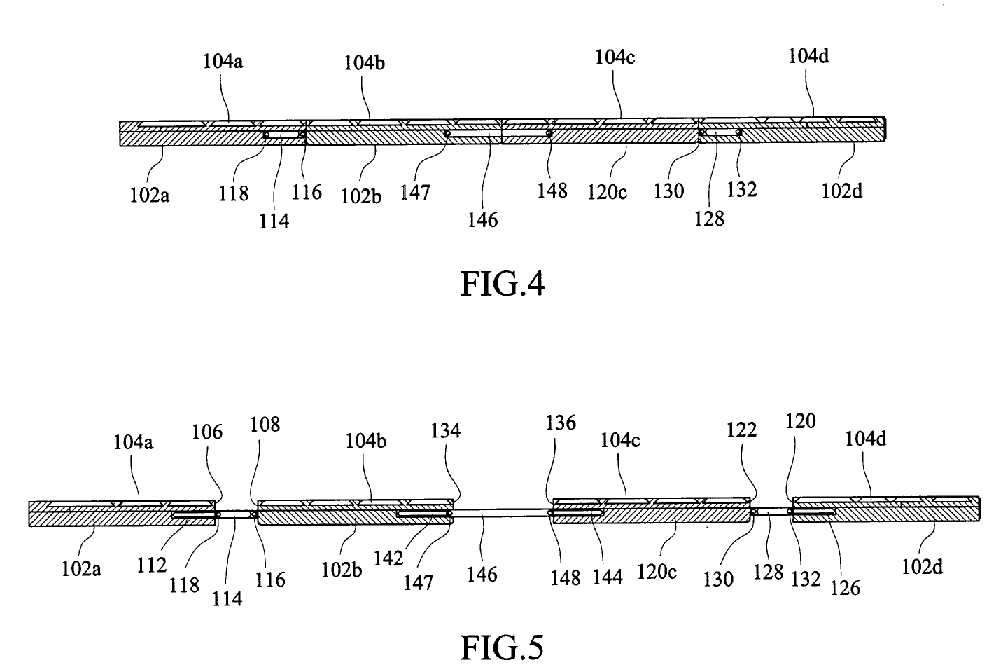

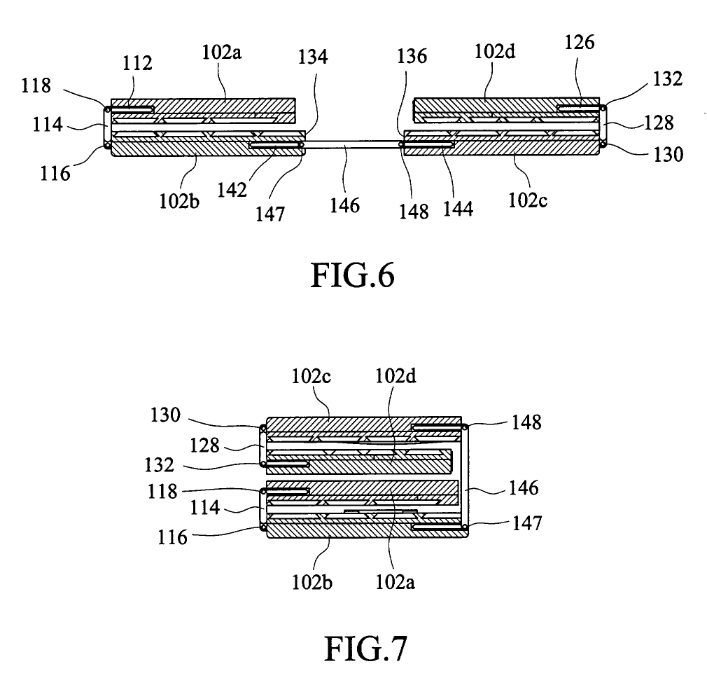

The tabs 114 are sized to allow the second segment 102b to move from a retracted position where the tabs 114 are completely received in the channels 110 and where the inner edge of the first segment 102a and the first edge of the second segment 102b engage each other as shown in FIG. 4 to an extended position where the tabs 114 are completely pulled out of the channels 110 and where the inner edge of the first segment 102a and the first edge of the second segment 102b are separated from each other a distance corresponding to the size of the tabs 114 as shown in FIG. 5. The size of the tabs 114 allows the first segment 102a to rotate in sequence about the pivot 116 and pivot pins 118 to overlap on the second segment 102b as shown in FIG. 6.

Similarly, the fourth segment 102d has an inner edge 120 facing a third edge 122 of the third segment 102c. Two channels 124 are formed in the inner edge 120 of the fourth segment 102d and defined by two opposite side walls (not labeled). A guide slot 126 is formed in each side wall of the channel 124. Two tabs 128 have an end (not labeled) rotatably connected to the third edge 122 of the third segment 102c by a pivot 130 and an opposite end (not labeled) movably received in each of the channels 124. Thus, the tabs 128 are retrievably received in the channels 124. Pivot pins 130 extend from opposite sides of each tab 128 and are movably received in the guide slots 126 for guiding the movement of the fourth and third segments 102d, 102c relative to each other. Each slot 126 is terminated with a rounded end for rotation of the pivot pins 132 therein. Thus, the tabs 128 are rotatable with respect to the fourth and third segments 102d, 102c about the pivots 132 and 130.

The tabs 128 are sized to allow the third segment 102c to move from a retracted position where the tabs 128 are completely received in the channels 126 and where the inner edge of the fourth segment 102d and the third edge of the third segment 102c engage each other as shown in FIG. 4 to an extended position where the tabs 128 are completely pulled out of the channels 124 and where the inner edge of the fourth segment 102d and the third edge of the third segment 102c are separated from each other a distance corresponding to the size of the tabs 128 as shown in FIG. 5. The size of the tabs 128 allows the fourth segment 102d to rotate in sequence about the pivot 130 and pivot pins 132 to overlap on the third segment 102c as shown in FIG. 6.

The second and third segments 102b, 102c have second and fourth edges 134, 136, each forming two channels 138, 140 defined by two opposite side walls. Each side wall forms a slot 142, 144. A central tab 146 has two ends respectively and movably received in the channels 138, 140. Each end of the central tab 146 forms two opposite pivot pins 147, 148 movably received in the slots 142, 144 whereby the tabs 146 are movable relative to the second and third segments 102b, 102c for guiding the movement of the second and third segments 102b, 102c with respect to each other. Each slot 142, 144 is terminated with a rounded end whereby the central tab 146 is rotatable with respect to the second and third segments 102b, 102c about the pivots 147, 148.

The central tabs 146 are sized to allow the second and third segments 102b, 102c to move from a closed position where the central tabs 144 are completely received in the channels 138, 140 and where the second and fourth edges of the second and third segments 102b, 102c engage each other as shown in FIG. 4 to an open position where the central tabs 146 are completely pulled out of the channels 138, 140 and where the second and fourth edges of the second and third segments 102b, 102c are separated from each other a distance corresponding to the size of the central tabs 146 as shown in FIG. 5. The size of the central tabs 146 allows the second and third segments 102b, 102c, together with the first and fourth segments 102a, 102d respectively overlapping on the second and third segments 102b, 102c, to respectively rotate about the pivots 147, 148 to overlap each other with the first and fourth segments 102a, 102d interposed therebetween as shown in FIG. 7.

FIGS. 4-6 shows the operation of folding the keyboard 100. Presuming the keyboard 100 is initially arranged in an operative condition as shown in FIG. 4. The folding operation of the keyboard 100 is achieved by first pulling the segments 102a, 102b, 102c, 102d in opposite direction, causing the tabs 114, 128 and the central tabs 146 to slide out of the channels 110, 124, 138, 140 to form an unfolded condition as shown in FIG. 5. The first and fourth segments 102a, 102d are folded over the second and third segments 102b, 102c respectively to form a stack, as shown in FIG. 6. The stacks are then folded over each other to form a fully folded condition as shown in FIG. 7.

Also referring to FIGS. 8 and 9, the keyboard 100 further comprises a battery module 200 removably received in a first recess 202 defined in the third segment 102c of the keyboard 100. The battery module 200 comprises connection means having a first portion 204 formed on the battery module 200 and engageable with a second, mating connection portion 206 formed in the recess 202 to electrically connect the battery module 200 to the keyboard 100. A guide slot 208 is defined in and co-extensive with each side edge of the battery module 200 for receiving and being guided by ribs 210 formed on opposite side walls of the recess 202. Latch means (not shown) is provided to releasably retain the battery module 200 in the first recess 202. A manual release button 212 is formed on the keyboard 100 for releasing the battery module 200.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A foldable computer keyboard comprising:
a first and second segments separating from each other, the first segment having an inner edge confronting a distal edge of the second segment, a channel being formed in the inner edge of the first segment and defined by opposite side walls, each side wall defining a slot terminating at a rounded end;
a connecting tab having a first end movably received in the channel and a second end pivotally attached to the distal edge of the second segment, the first end forming pivot pins extending from opposite sides of the connecting tab and movably received in the slots of the channel whereby the connecting tab is rotatable with respect to the first segment about the pivot pins located at the rounded ends of the slots to allow the segments to overlap each other.

2. The foldable computer keyboard as claimed in claim 1 further comprising a third segment having a proximal edge confronting a proximal edge of the second segment, the proximal edges of the second and third segments each forming a channel defined by two side walls, each side wall forming a slot terminating at a rounded end, a central tab having two ends respectively and retrievably received in the channels of the second and third segments, each end of the central tab forming opposite pivot pins movably received in the slots whereby the central tab is rotatable with respect to the second and third segments about the pivot pins at the rounded ends of the slots for overlapping the segments.

3. The foldable computer keyboard as claimed in claim 2 further comprising a fourth segment having an inner edge confronting a distal edge of the third segment, the inner edge of the fourth segment forming a channel defined by two side walls, each side wall forming a slot terminating at a rounded end, a first end of a connecting tab being movably received in the channel and a second end pivotally attached to the distal edge of the third segment, the first end forming pivot pins extending from opposite sides of the connecting tab and movably received in the slots of the channel whereby the connecting tab is rotatable with respect to the fourth segment about the pivot pins located at the rounded ends of the slots to allow the third and fourth segments to overlap each other.

4. A foldable computer keyboard comprising:
a first and second central segments separating from each other, the first central segment having a proximal edge confronting a proximal edge of the second central segment, the proximal edges of the first and second central segments each forming a channel defined by two side walls, each side wall forming a slot terminating at a rounded end; and
a central tab having two ends respectively and retrievably received in the channels of the first and second central segments, each end of the central tab forming opposite pivot pins movably received in the slots whereby the central tab is rotatable with respect to the first and second central segments about the pivot pins at the rounded ends of the slots for overlapping the central segments.

5. The foldable computer keyboard as claimed in claim 4 further comprising:
at least an external segment engaging to a distal edge of the central segment, the external segment having an inner edge confronting a distal edge of the central segment, a channel being formed in the inner edge of the external segment and defined by opposite side walls, each side wall defining a slot terminating at a rounded end; and
a connecting tab having a first end movably received in the channel and a second end pivotally attached to the distal edge of the central segment, the first end forming pivot pins extending from opposite sides of the connecting tab and movably received in the slots of the channel whereby the connecting tab is rotatable with respect to the external segment about the pivot pins located at the rounded ends of the slots to allow the segments to overlap each other.
